(19) United States
(12) Patent Application Publication
(10) Pub. No.: US 2014/0202319 A1
(43) Pub. Date: Jul. 24, 2014

(54) ELECTROSTATIC INTERFERENCE SHIELD FOR MUSICAL INSTRUMENT PICKUPS

(71) Applicant: Gary Thomas Osborne, Indianapolis, IN (US)

(72) Inventor: Gary Thomas Osborne, Indianapolis, IN (US)

(21) Appl. No.: 14/159,958

(22) Filed: Jan. 21, 2014

Related U.S. Application Data
(60) Provisional application No. 61/754,961, filed on Jan. 21, 2013.

(51) Int. Cl. G10H 3/18

(52) U.S. Cl. CPC G10H 3/181
USPC 84/728

(57) ABSTRACT

A musical instrument pickup with electrostatic interference (ESI) shield that reduces audible ESI noise in an audio output signal sent to an audio amplifier. The pickup includes an electrostatically sensitive surface, a carbon coating shielding the surface, and a ground conductor electrically connected to the carbon coating to carry a reference potential of the amplifier to the carbon coating. The carbon coating can include a conductive metal component. The coated surface can be a pickup cover, base, bobbin, or other component. The audio amplifier can include an input terminal and a ground terminal having the reference potential, and the pickup can include an electrical connection carrying the pickup audio output signal to the amplifier input terminal, and another electrical connection carrying the reference potential from the amplifier ground terminal to the pickup ground conductor.

This application claims priority to U.S. Provisional Patent Application Ser. No. 61/754,961, filed Jan. 21, 2013 entitled “Electrostatic Interference (ESI) Shield for Musical Instrument Pickups,” the disclosure of which is expressly incorporated herein by reference.

### BACKGROUND AND SUMMARY

The present invention generally relates to musical instrument pickups, and more specifically to electrostatic interference shields for musical instrument pickups.

Electrostatic interference (ESI) noise includes AC hum and static. It contaminates the audio output signal of a musical instrument pickup with undesired sounds that may sound like hums, buzzes, crackles, or non-musical tones. It would be desirable to provide an improved ESI shield for pickups of musical instruments to decrease the ESI noise.

An improved ESI shield could be incorporated into a variety of pickup types to decrease or eliminate the ESI noise. Some common pickup types in which the improved ESI shield has been successfully installed and tested are single-coil pickups, double-coil pickups (which are also known as humbuckers or hum-bucking pickups), piezoelectric pickups, contact microphones, and under-bridge pickups (which are also known as under-saddle pickups).

A musical instrument pickup with an electrostatic interference (ESI) shield is disclosed, where the ESI shield substantially reduces audible ESI noise in an audio output signal of the pickup to be sent to an audio amplifier. The musical instrument pickup includes an electrostatically sensitive surface, a carbon coating shielding the electrostatically sensitive surface, and a ground conductor electrically connected to the carbon coating to carry a reference potential of the audio amplifier to the carbon coating. The carbon coating can include one or more of the following materials: carbon, carbon black, graphite, and an allotrope of carbon. The carbon coating can include an electrically conductive component that includes metal. The carbon coating can include a solvent for chemically etching the electrostatically sensitive surface to help adhere the carbon coating to the electrostatically sensitive surface. The surface with the carbon coating can be a pickup cover, a pickup base, a bobbin top, a split bobbin, a wire bobbin, a plastic tube, and a tube casing. The surface with the carbon coating can shield a bobbin with a coil of wire. The surface with the carbon coating can be an inner wire of a shielded cable. The surface with the carbon coating can be an exterior surface of the musical instrument pickup, and the carbon coating can be black in color. The ground conductor can include a copper foil, a bare wire, a spring, a pole piece, a conductive coating, and/or a second carbon coating. The musical instrument can also include a solvent guard for keeping the carbon coating off of an electrically conductive element of the musical instrument pickup. The audio amplifier can include an input terminal and a ground terminal having the reference potential, and the musical instrument pickup can also include a first electrical connection for carrying the audio output signal of the musical instrument pickup to the input terminal of the audio amplifier, and a second electrical connection for carrying the reference potential from the ground terminal of the audio amplifier to the ground conductor of the ESI shield of the musical instrument pickup.

A musical instrument pickup is disclosed that includes a coil of wire for producing an audio output signal, a pole piece inside the coil of wire, a conductive coating in electrical contact with the pole piece, and a ground conductor electrically connected to the conductive coating for carrying a reference potential to the pole piece to shield the inside of the coil of wire from electrostatic interference (ESI) noise. The musical instrument pickup can also include a bobbin for the coil of wire and the conductive coating, wherein the coil of wire is wound on the bobbin and the conductive coating is applied to an inner surface of the bobbin. The ground conductor can include a copper foil, a bare wire, a spring, a pole piece, a second conductive coating, or a carbon coating. The conductive coating can include an electrically conductive component not made of carbon, or an electrically conductive component made of carbon. The musical instrument pickup can include a second coil of wire.

A pickup is disclosed for a musical instrument that includes a coil of wire for providing an audio output signal, an external top surface of the pickup, a conductive coating applied to the external top surface of the pickup, and a ground conductor electrically connected to the conductive coating for carrying a reference potential of an audio amplifier to the conductive coating to shield the pickup from electrostatic interference (ESI) noise. The conductive coating can be black in color. The conductive coating can include carbon, carbon black, graphite, an allotrope of carbon, silver, or copper. The conductive coating can include a colorant. The pickup can include an overcoating over the conductive coating. The pickup can include a second coil of wire.

A pickup is disclosed for a musical instrument that includes a coil of wire for providing an audio output signal; a plurality of pole pieces located in the coil of wire; and a spring for applying contact forces to the pole pieces to provide electrical connections between the spring and the pole pieces. The pickup can also include a base of the pickup and a conductive coating applied over the base, where the spring is electrically connected to the base. The pickup can also include a ground wire electrically connected to the base to apply the reference potential of an audio amplifier to the base, the conductive coating, the spring, and the pole pieces. The pickup can include a bobbin for the coil of wire and a conductive coating applied over the top surface of the bobbin. The pickup can include a base with a hole, where each of the pole pieces extends through the base. The spring can include a wire weaved between the pole pieces to provide the contact forces to the pole pieces.

For a more complete understanding of the present disclosure, reference is now made to the following detailed description and the accompanying drawings.

### BRIEF DESCRIPTION OF THE DRAWINGS

FIG. 1 is a top view of an exemplary embodiment of a single-coil musical instrument pickup with ESI shielding;

FIG. 2 is a cross-section view of the exemplary pickup of FIG. 1;

FIG. 3 is a bottom view of the exemplary pickup of FIG. 1;

FIG. 4 is a top view of the exemplary pickup of FIG. 1 with the pickup cover removed;

FIG. 5 is a bottom view of an exemplary pickup cover for the exemplary pickup of FIG. 1;

FIG. 6 is a top view of another exemplary embodiment of a single-coil musical instrument pickup with ESI shielding;

FIG. 7 is a cross-section view of the exemplary pickup of FIG. 6;

FIG. 8 is a bottom view of the exemplary pickup of FIG. 6;

FIG. 9 is a top view of an exemplary split bobbin for the exemplary pickup of FIG. 6;

FIG. 10 is a side view of the exemplary split bobbin of FIG. 9;

FIG. 11 is a top view of an exemplary embodiment of a hum-bucking musical instrument pickup with ESI shielding;

FIG. 12 is a cross-section view of the exemplary pickup of FIG. 11;

FIG. 13 is a side view of an exemplary embodiment of a piezoelectric musical instrument pickup with ESI shielding;

FIG. 14 is a top view of another exemplary embodiment of a single-coil musical instrument pickup with ESI shielding;

FIG. 15 is a cross-section view of the exemplary pickup of FIG. 14;

FIG. 16 is a schematic diagram of the exemplary pickup of FIG. 14 with an audio amplifier and a shielded cable;

FIG. 17 is a top view of another exemplary embodiment of a hum-bucking musical instrument pickup with ESI shielding;

FIG. 18 is a bottom view of the exemplary pickup of FIG. 17; and

FIG. 19 is a cross-section view of the exemplary pickup of FIG. 17.

### DESCRIPTION OF PREFERRED EMBODIMENTS

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

An ESI shield for a musical instrument pickup can include an electrically conductive, carbon coating of carbon, carbon black, graphite and/or other allotropes of carbon mixed in various proportions with other chemicals. These carbon substances can be referred to collectively or singularly as carbon. The carbon can be mixed with a liquid solvent, paint, or ink which can be painted onto one or more surfaces of the pickup. When the paint dries an electrically conductive carbon coating is left adhered to the surfaces. An ohmmeter can be utilized to verify the electrical conductivity of the dried carbon coating and to measure its electrical resistance.

The carbon can be deposited onto the pickup surface by various methods, wet or dry. The deposition method for low volume production or prototype work can be for a person to manually brush the carbon/paint mixture wet onto the pickup surface and let it air-dry. However, any deposition method that creates an electrically conductive carbon coating can be acceptable. For example, the carbon/paint can be applied via a compressed-air paint sprayer, or the carbon can be applied without paint by a hot sprayer, xerography method, ink jet, or laser printer.

The carbon coating may include a solvent that causes it to chemically etch and adhere to an underlying substrate of the pickup such as the surface of a plastic pickup cover. The carbon coating can be made to resist rubbing off to the touch and/or can be made to withstand large temperature changes without cracking.

Mediums other than paint may also be suitable for the carbon coating. For example, the carbon can be mixed with glue, epoxy, or liquid urethane and hardener. Or there can be no medium. The carbon can be heated and sprayed onto a plastic surface where it momentarily melts the plastic and bonds to its surface. Regardless of the deposition method or medium employed, the objective is to create the carbon coating with electrical conductivity that can be verified by the ohmmeter. While different kinds of mediums and machinery can be utilized to deposit the carbon coating, simple tools like carbon, a suitable liquid medium, and a paint brush may also be used to apply the carbon coatings.

Other materials such as powdered silver or copper/silver, or nickel can be employed in conjunction with the carbon or to replace the carbon. When an electrically conductive component (ECC) of the coating is primarily carbon or metal or any conductive material, the coating may be referred to as a conductive coating. When the ECC is primarily carbon, the coating may be referred to as a carbon coating. When the ECC is primarily metal, the coating may be referred to as a metal coating. A hybrid coating is a mixture of any of the coating types. Unless otherwise noted, a metal coating typically has negligible amounts of carbon, and a carbon coating typically has negligible amounts of metal. A conductive coating may have any kind of ECC—metal, carbon or other conductive material. But the ECC of any coating may be modified when duly noted. Table 1 gives the names of various exemplary coatings and their ECC components which are as shown unless noted otherwise in the specification of any given coating.

TABLE 1
Coating Names

| | ELECTRICALLY CONDUCTIVE COMPONENT |
|---|---|
| COATING NAME | (ECC) |
| Carbon Coating | primarily carbon, carbon black, graphite and/or |
| | allotropes of carbon |
| Conductive Coating | any conductive substances |
| Metal Coating | one or more types of metals |
| Hybrid Coating | determined by the components that make up the |
| | hybrid coating |

A pickup designer can elect to combine the coatings (wet or dry) into a hybrid coating to achieve a desired ESI shielding, to facilitate manufacturing, to reduce cost, or to meet other design objectives. Metals may be less desirable because they can be more expensive than carbon. While a metal coating can have a lower resistance reading than a carbon coating, the carbon coating has low enough resistance to provide effective ESI shielding even when it has no metal. Carbon coatings are also typically black in color while metal coatings are typically not black. Since a variety of conventional pickups are black, the carbon coating can conveniently be applied directly to the exterior surface of a black pickup without changing its color. The metal coatings may need an overcoating such as black paint or a black colorant to make them black.

A carbon coating can make a new pickup appear to be a vintage pickup. The carbon coating can create a subtly flawed surface finish which may be less uniform in color, texture, and reflectivity than other finishes that are achievable through modern manufacturing methods. A flawed finish can give a carbon-coated pickup a competitive advantage in the marketplace for vintage musical equipment. Some pickup manufacturers strive to produce pickups having high quality finishes with excellent uniformity of color, texture, and reflectivity that appear flawless to the naked eye. However, others may desire to produce an imperfect finish.

A ground conductor can carry a reference potential voltage of an audio amplifier to the ESI shield. The audio amplifier has one or more input terminals and a ground terminal that has the reference potential. In the conventional manner, electrical connections are made between the pickup and the amplifier terminals to carry the pickup's audio output signal to the amplifier input terminal and to carry the reference potential from the amplifier ground terminal to the pickup. The audio amplifier amplifies the pickup audio output signal and produces an output for speakers or for other audio equipment.

The pickup may have one or more coils of wire, piezo elements, or microphones to produce its audio output signal. Of course the electrical connections between the pickup and the amplifier terminals may include wires, cable, volume controls, tone controls, preamplifiers, signal processors, mixers, and/or the like to carry the pickup audio output signal and the reference potential.

The ground conductor receives the amplifier's reference potential from the amplifier ground terminal. However, the ground conductor does not need a direct physical connection to the amplifier ground terminal because any number of devices with electrical connections can be utilized to carry the reference potential to the ground conductor. For example, the ground conductor can be a wire soldered to a potentiometer terminal inside a musical instrument such as an electric guitar. The potentiometer terminal can be connected in the conventional manner to the amplifier reference potential via the sleeve terminal of a ¼ inch phone jack, a ¼ inch phone plug, and an instrument cable which is connected to an input jack of the audio amplifier. Alternatively, the guitar may have an internal cavity with its own carbon coating which is electrically connected to the reference potential via the ¼ inch phone jack. In this embodiment, the pickup can be installed inside the cavity and its ground conductor electrically connected to the cavity's carbon coating to receive the reference potential.

A carbon coating ESI shield can be arranged to shield electrostatically sensitive portions of a pickup from electrostatic radiation and thus reduce audible ESI noise in the pickup audio output signal. The ESI sensitive portions can be partially or completely encased within the reference potential by the carbon coating ESI shield. A substantial noise reduction of 10 dB or more can be achieved.

Noise reduction can be measured by an AC RMS voltmeter or equivalent. A noise reduction measurement can be made by the following steps. First, connect the pickup to the amplifier with the ground conductor disconnected, touch the pickup with your hand and measure the amplifier's output voltage V1 with the voltmeter. Next, connect the ground conductor to the amplifier ground terminal to carry the reference potential to the ESI shield. Then, touch the pickup with your hand again and measure the amplifier's output voltage V2 with the voltmeter. The noise reduction (NR) in decibels can be calculated by:

NR=20*log(V1/V2)dB

A value of NR greater than zero indicates that the ESI shield is decreasing the ESI noise of the pickup.

Electrostatically sensitive portions of the pickup are portions of the pickup that when touched by a person's hand, produce a buzz, hum, or static sound in the pickup's audio output signal. The sound can be louder when you are standing or seated on an electrical insulator so that there is no electrical connection between the person and the amplifier's reference potential.

A carbon coating can reduce the ESI noise of a pickup without substantially affecting its physical appearance because the carbon coating can be applied to interior surfaces of the pickup. Also, when a pickup is intended to be black in color, a carbon coating can be applied to exterior surfaces of the pickup. A carbon coating can make the coated surfaces black without the need for an additional coating of paint. A carbon coating can be a finish coating and an ESI shield. A carbon coating can reduce the ESI noise of a pickup without substantially affecting its sound quality because the weak diamagnetic property of carbon and graphite cause negligible distortion of the pickup's permanent magnetic field.

A carbon coating can be applied to an inside surface of a pickup cover where it is separated from the pickup coil by an air gap. In the pickup design, the air gap can be utilized to increase the distance between the carbon coating and the coil to decrease any stray capacitive loading effect on the coil by the carbon coating's reference potential. This decreases the carbon coating's effect on the coil's self-resonant frequency.

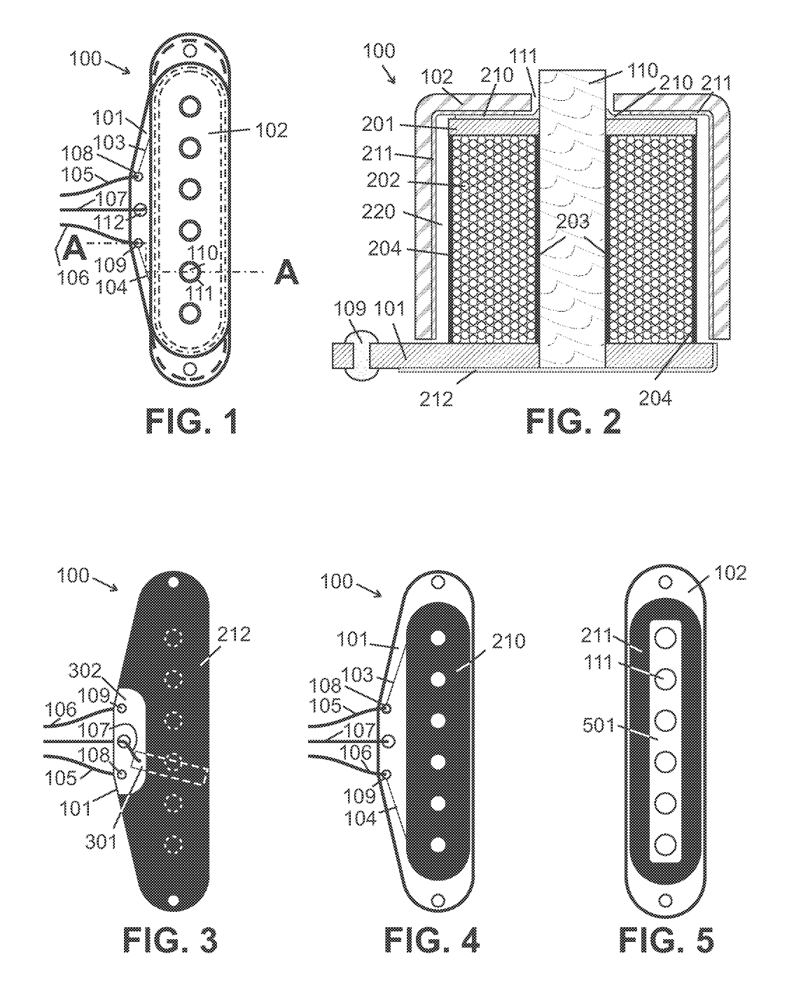

FIG. 1 illustrates a top view of an exemplary embodiment of a single-coil pickup 100. The pickup 100 includes a pickup base 101, two coil wires 103,104, a pickup cover 102 having six holes in its top, and a permanent magnet pole piece 110 which protrudes through one of the holes 111 in the cover 102. The base 101 and the cover 102 are electrical insulators that can be made of the usual materials such as fiber board, plastic, paper, or the like. The base 101 includes a hole 112 and two solder eyelets 108,109. A ground wire 107 passes through the hole 112 in the base 101. The solder eyelet 108 of the base 101 is soldered to a signal wire 105 and the coil wire 103. The solder eyelet 109 of the base 101 is soldered to a signal wire 106 and the coil wire 104.

FIG. 2 illustrates a cross-section view A-A of the pickup 100. It shows various components located inside the cover 102. A coil of wire 202, which can be wound of enameled copper wire (also known as magnet wire), begins and ends with the coil wires 103,104 respectively. Two electrical insulators 203, 204, which can be made of adhesive tape, are on the inside and outside of the coil of wire 202. A bobbin top 201 on top of the coil of wire 202 has a top conductive coating 210 applied to its top surface. An inside carbon coating 211 is applied to the inside of the cover 102. The insulators 203, 204, and the bobbin top 201 are electrical insulators. An air gap 220 exists between the inside coating 211 and the coil 202. The electrical insulator 204 is optional.

FIG. 2 also shows the solder inside the eyelet 109 and a bottom carbon coating 212 that is applied to the underside of the base 101. The bottom coating 212 is in electrical contact with the pole piece 110. The pole piece 110 is an ordinary pickup magnet made of an electrically conductive iron alloy. The pole piece 110 is both a permanent magnet and an electrical conductor. The pole piece 110 is in direct physical contact with the conductive coating 210 and the carbon coating 212 to insure that all three elements carry the amplifier reference potential.

FIG. 3 illustrates a bottom view of the pickup 100. It shows a piece of ground conductor copper foil 301 that is in contact with the bottom of the base 101. The ground wire 107 is soldered to the foil 301. The bottom coating 212 is applied over of the foil 301 to improve the reliability of its electrical connection to the foil 301.

With the exception of a masked area 302 where there is no coating, the bottom coating 212 is applied to the entire bottom surface of the base 101. The area 302 can be masked by an adhesive tape before the bottom coating 212 is applied to prevent the coating 212 from contacting the eyelets 108,109. The tape can be removed before the pickup 100 is assembled.

FIG. 4 illustrates a top view of the pickup 100 with the cover 102 removed. It shows that the top coating 210 is applied to the entire top surface of the bobbin top 201. To improve the reliability of the electrical connections between the pole pieces and the top coating 210, the top coating 210 can be applied over any part of the surface of the pole pieces that protrude through the holes in the bobbin top 201.

FIG. 5 illustrates a bottom view of the cover 102. It shows the inner coating 211 which is applied to the inside surface of the cover 102. With the exception of a masked area 501, the inner coating 211 can be applied to the entire inside surface of the cover 102 except for the masked area 501. The masked area 501 can be masked by adhesive tape before the coating 211 is applied so that the coating 211 does not spill or leak through the hole 111 or any other of the six holes in the top of cover 102. The tape is removed from the masked area 501 after the inner coating 211 dries and before the pickup 100 is assembled.

When the pickup 100 is assembled, the top coating 210 is in direct physical contact with the inner coating 211 insuring that both coatings have the same electrical potential. A result of the assembly is that an electrical connection is made between coatings 210 and 211. The assembly completes a pathway of electrical connections which begins at the ground wire 107 and extends through the foil 301, the bottom coating 212, the pole piece 110, the top coating 210, and the inner coating 211. The electrical connections carry the amplifier reference potential from the ground wire 107 throughout the ESI shield which includes the coatings 210, 211, 212 and the pole piece 110.

In operation, electrical connections are made between the pickup 100 and the audio amplifier in the usual manner that a pickup within a musical instrument is connected to an audio amplifier. The connections carry the pickup audio output signal from the coil 202 via the signal wires 105,106 to the audio amplifier's input terminal and ground terminal. To achieve the ESI noise reduction, electrical connections are made between the ground wire 107 and the audio amplifier ground terminal to carry the reference potential of the audio amplifier to the ground wire 107. In practice, the pickup 100 is normally operated in a single-ended mode where one of the signal wires 105, 106 is connected to the amplifier reference potential and the other signal wire 105, 106 is the “hot” wire (having the pickup audio output signal) which is carried to the amplifier input terminal.

A single-ended operating mode is not required. Instead for example, the pickup 100 can be operated in a differential mode where the signal wires 105,106 have independent connections to an inverting input terminal and a non-inverting input terminal respectively of a differential input of the audio amplifier. Regardless of whether the pickup 100 is operated in differential mode or single-ended mode, connections are made to carry the amplifier reference potential to the ground wire 107 to “energize” the ESI shield.

In the embodiment of FIGS. 1-5, the pole piece 110 is both a permanent magnet and a ground conductor located inside the coil 202. The physical contact of the pole piece 110 with the coatings 210, 211, 212 enables the pole piece 110 to electrically connect the coatings 210, 211, 212 together. The location of the pole piece 110 makes it part of the ESI shield and enables it to shield the inside of the coil 202 from ESI noise. The ESI shielding property of the pole piece 110 is especially noticeable when a human hand touches the pole piece 110 and there is no significant increase in ESI noise as a result. Likewise, when the ground wire 107 is disconnected from the amplifier reference potential, the lack of ESI shielding by the pole piece 110 is noticeable when human touch increases the ESI noise.

The pole piece 110 does not have to be utilized as a ground conductor. Instead, an additional wire, foil, or conductive coating can be added around the coil 202 to electrically connect together the two coatings 210 and 212. It should also be noted that the conductive coating 210 is preferably a carbon coating in order to gain the advantages described above. But conductive coating 210 can be a different kind of coating.

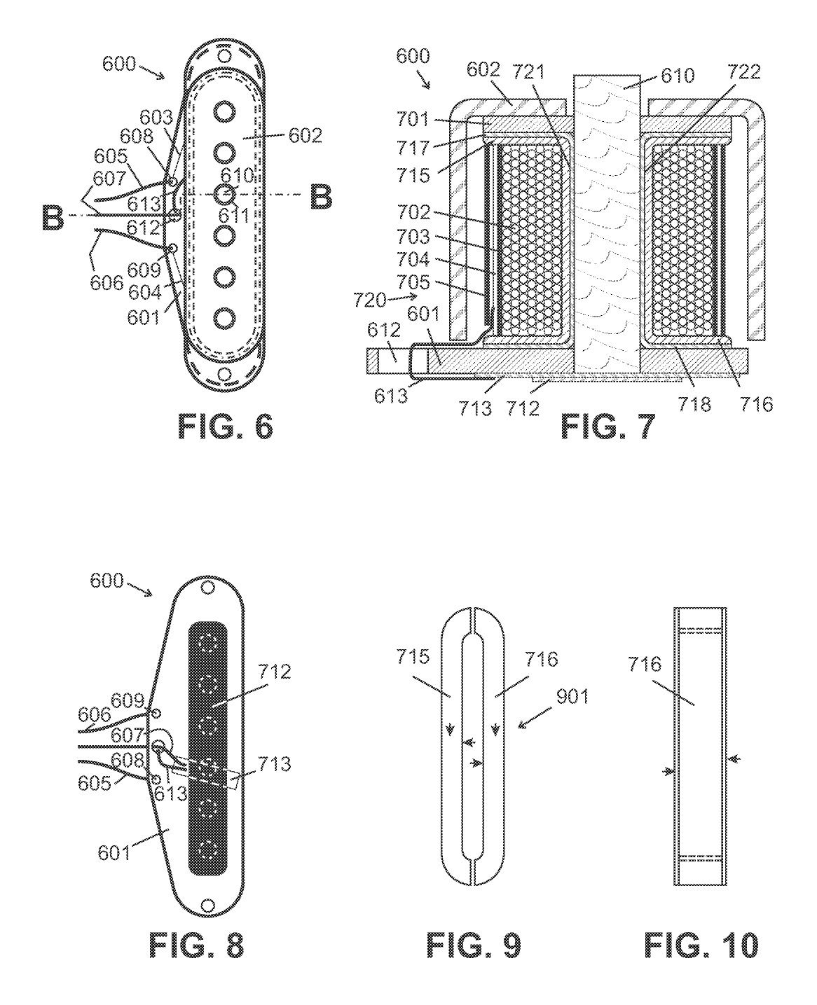

FIG. 6 shows a top view of an alternative embodiment of a single-coil pickup 600 with ESI shielding. The pickup 600 includes a base 601, a pickup cover 602, a permanent magnet pole piece 610 which protrudes through a hole 611 in the cover 602, and two coil wires 603, 604. The base 601 includes a hole 612 and two solder eyelets 608, 609. A ground wire 607 and a connecting wire 613 pass through the hole 612. The solder eyelet 608 is soldered to a signal wire 605 and the coil wire 603. The solder eyelet 609 is soldered to a signal wire 606 and the coil wire 604. The base 601 and the cover 602 are electrical insulators.

FIG. 7 shows a cross section B-B view of the pickup 600. It shows the following components that are located inside the cover 602; a wire coil 702 that begins and ends with the coil wires 603, 604 respectively; two electrical insulators 703, 705 which can be made of adhesive tape; a bobbin top 701 made of electrical insulator material; and two split bobbins 715, 716 made of an electrical insulator, for example plastic. The cross section also shows the hole 612, a bottom conductive coating 712 and the connecting wire 613 which is soldered to a piece of conductive foil 713 that is between the conductive coating 712 and the base 601. The conductive foil 713 can be copper foil. The bottom coating 712 is in electrical contact with the pole piece 610 and the foil 713. The pole piece 610 is made of an electrically conductive iron alloy.

Two conductive coatings 717, 718 are applied to the top surfaces, the bottom surfaces, and the inner surfaces 721, 722 of the bobbins 715, 716 respectively. These coatings do not come in contact with the coil 702 but they do make electrical contact with the pole piece 610.

On the outside perimeter surface of the coil 702 there is an electrical insulator layer 703, followed by a perimeter layer 704, which is followed by another insulator layer 705. The insulator layers 703, 705 can be made of adhesive tape. The perimeter layer 704 can be made of carbon coating or copper foil. The connecting wire 613 makes an electrical connection between the perimeter layer 704 and the foil 713. As a result of these electrical connections, the coil 702 is encased by an ESI shield 720 comprising the coatings 717, 718 and the perimeter layer 704.

FIG. 8 shows a bottom view of the pickup 600. It shows the ground wire 607 and the connecting wire 613 soldered to the foil 713. The bottom coating 712 is applied over the foil 713 to improve the reliability of the electrical connection. The bottom coating 712 is smaller in area in comparison to the bottom coating 212 of FIG. 3 because the coating 712 is not needed to shield the coil 702 in this embodiment. Instead the bottom coating 712 is a ground conductor that provides an electrical connection between the foil 713 and the pole piece 610.

FIG. 9 shows a top view of the split bobbins 715, 716 which can be two substantially identical pieces. This drawing was created with a short-hand method to indicate coatings. The short arrows indicate which surfaces of the split bobbins 715, 716 have conductive coatings applied. Similarly, FIG. 10 is a side view of the split bobbin 716 where short arrows indicate the surfaces with conductive coating.

In practice, a carbon coating can be applied to the surfaces of the split bobbins 715, 716 as shown by the short arrows. Then the split bobbins 715, 716 are assembled together as shown in FIG. 9. Adhesive tape can be wrapped around the split bobbins 715, 716 to hold them together and create a wire bobbin 901. Wire is wound around the bobbin 901 to create the coil 702. A carbon coating can be applied to the perimeter surface of the adhesive tape 703 to create the perimeter layer 704.

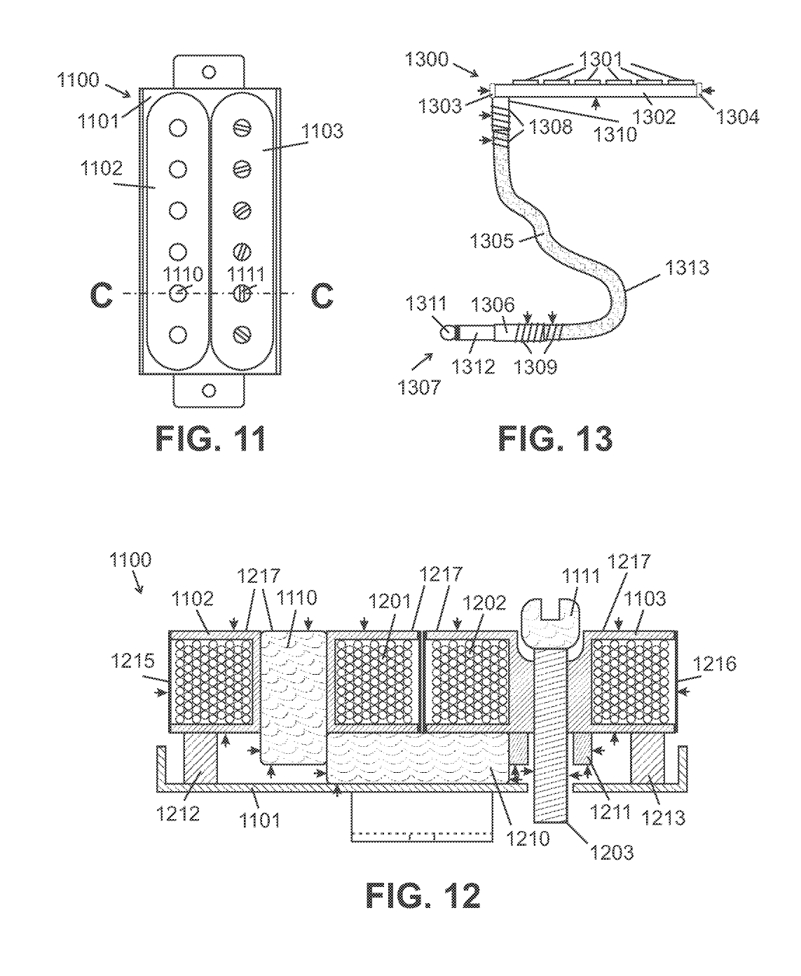

FIG. 11 illustrates a top view of an exemplary embodiment of a double-coil (hum-bucking) pickup 1100 with ESI shielding. The pickup 1100 includes a base 1101, a left wire bobbin 1102, a right wire bobbin 1103, and two pole pieces 1110, 1111. The pickup 1100 also has a ground wire (not shown) which is electrically connected to the base 1101 by solder, and one or more signal wires (not shown) connected to coils in the bobbins 1102, 1103. The bobbins 1102, 1103 are electrical insulators. The base 1101 and the pole pieces 1110, 1111 are electrically conductive and preferably made of metal. The pole pieces 1110, 1111 are made of a magnetic material such as steel or a ferrous metal alloy.

FIG. 12 shows a cross-section view C-C of the pickup 1100. It shows a coil of wire 1201, a coil of wire 1202, the pole pieces 1110, 1111, a permanent magnet 1210, a magnet bar 1211, two spacers 1212, 1213, and perimeter insulators 1215, 1216. The magnet 1210 and the perimeter insulators 1215, 1216 are electrical insulators. The magnet bar 1211 is preferably made of steel. The perimeter insulators 1215, 1216 can be made of adhesive tape.

Several short arrows indicate the many surfaces of the pickup 1100 that have conductive coatings. Notice that an external top surface 1217 of the bobbins 1102, 1103 and the pole piece 1110 have a conductive coating. The result of all these conductive coatings is that the pickup 1100 is encased in an ESI shield which is electrically connected to the base 1101 and the pickup's ground wire. The conductive coating is applied over the bottom of each of the six pole pieces in the bobbin 1102 to make each more reliably grounded. There are no conductive coatings over the tops of the six pole pieces in the bobbin 1103 but there are conductive coatings applied to the bottoms of these six pole pieces.

FIG. 13 is a side view of an exemplary piezoelectric (under-bridge) pickup 1300. The pickup 1300 has six piezo stones 1301, an outer tube casing 1302 which can be made of plastic, and a shielded cable 1305 that has an inner wire 1314 (not shown) and a ground wire 1313, which is a braid of wire that is preferably not covered with an electrical insulator. The ground wire 1313 carries the audio amplifier's reference potential from a sleeve terminal 1312 of a miniature phone plug 1307 to the piezo stones 1301. The ground wire 1313 also shields the inner wire 1314 because it is braided around the inner wire 1314. There is an electrical insulator (not shown) between the inner wire 1314 and the ground wire 1313.

The inner wire 1314 carries the pickup audio output signal from the piezo stones 1301 to a tip terminal 1311 of the plug 1307. The inner wire 1314 is said to carry the pickup audio output signal for an input terminal of the audio amplifier because there are electrical connections between the tip terminal 1311 and the audio amplifier input terminal. An example of these electrical connections in one embodiment has the plug 1307 plugged into an input jack of a preamplifier box (not shown). The preamplifier box is located inside the musical instrument. The preamplifier takes the pickup audio output signal from the tip terminal 1311, amplifies it, and sends it to a preamp output jack, which is also known as a musical instrument output phone jack. One end of a shielded instrument cable is plugged into the instrument output phone jack while and the other end of the instrument cable is plugged into the input phone jack of the audio amplifier which is electrically connected to the input terminal of the audio amplifier.

Located around the braid of cable 1305 are two plastic tubes 1306, 1310 which are electrical insulators. To encase ESI-sensitive portions of this pickup, carbon coatings can be applied to the surfaces indicated by the short arrows. Two ground conductors 1308, 1309 can be made of spirals of bare wire wound around the plastic tubes 1306, 1310 respectively that are coupled to the ground wire 1313 at the ends of the shielded cable 1305. To make more reliable ground connections for carrying the amplifier reference potential, a carbon coating can be painted over the ground conductors 1308, 1309 after they are wrapped around the plastic tubes 1306, 1310. The carbon coating does not need to be applied to the entire length of the cable 1305 but can be applied on the cable ends over the ground conductors 1308, 1309.

To further ESI-shield the pickup 1300, the ends of the tube casing 1302 can be plugged-up with glue to form glue plugs 1303, 1304. Then, carbon coatings can be painted over the glue plugs 1303, 1304 and the tube casing 1302.

The shielded cable 1305 carries the audio amplifier's reference potential over electrical connections made through the various jacks, cables, and preamplifier box to the audio amplifier ground terminal. The audio amplifier's reference potential is carried from the sleeve terminal 1312 of the phone plug 1307 through the ground conductor 1309, ground wire 1313 and ground conductor 1308 to the tube casing 1302 and the piezo stones 130.

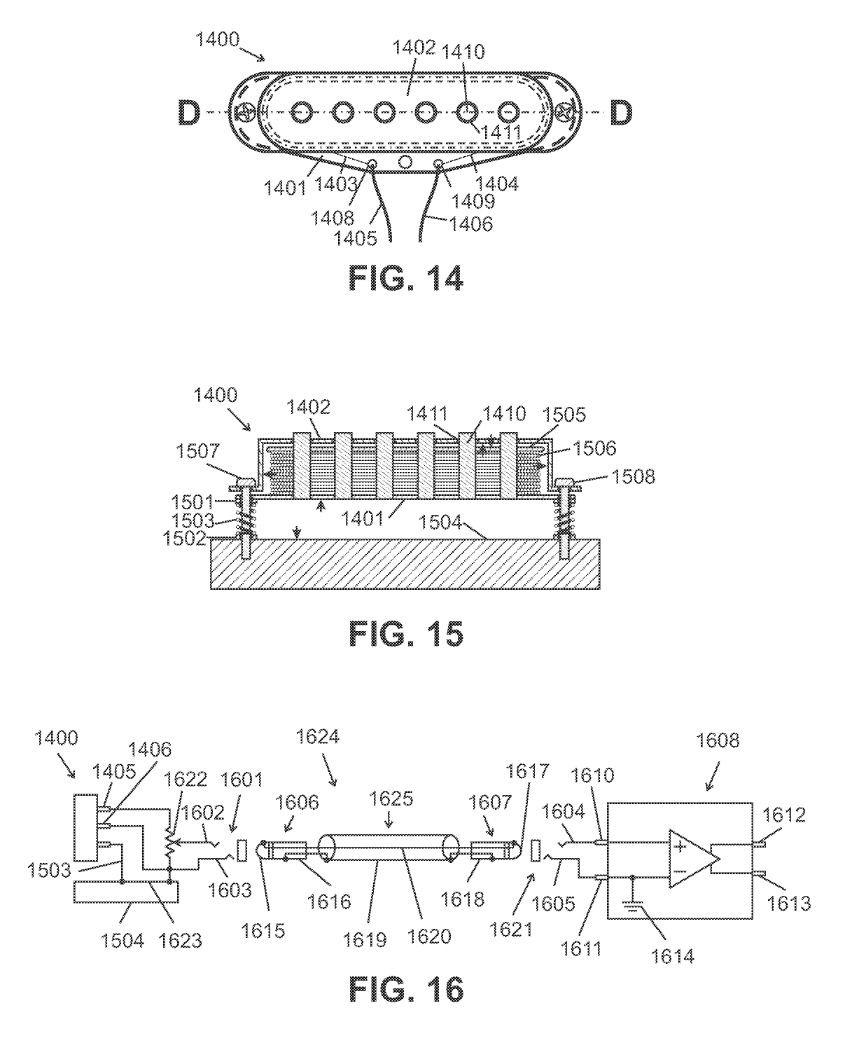

FIG. 14 is a top view of an exemplary single-coil pickup 1400 which is similar to the pickup 100 of FIG. 1 with the notable exception that there is no ground wire. The pickup 1400 has a pickup base 1401, two coil wires 1403, 1404, a pickup cover 1402 having six holes in its top, and a permanent magnet pole piece 1410 which protrudes through one of the holes 1411 in the cover 1402. The base 1401 includes two solder eyelets 1408, 1409. The solder eyelet 1408 is soldered to a signal wire 1405, 1406 and the coil wires 1403. The solder eyelet 1409 is soldered to a signal wire 1406 and the coil wires 1404. The base 1401 and the cover 1402 are electrical insulators.

FIG. 15 illustrates a cross-section view D-D of the pickup 1400. It shows a coil of wire 1506 which begins and ends with the coil wires 1403, 1404 respectively, a bobbin top 1505, and many short arrows to indicate the surfaces having conductive coatings. The pickup 1400 is affixed to a body 1504 of a musical instrument by two screws 1507, 1508. In this embodiment, there is a metal spring 1503 and two metal washers 1501, 1502 around each of the screw 1507, 1508.

In operation, the body 1504 has a carbon coating which has an electrical connection to the amplifier reference potential. The body's carbon coating is in physical contact with the washer 1502. The spring 1503 carries the reference potential up from the washer 1502 to the washer 1501 which is in electrical contact with a conductive coating under the base 1401. The conductive coating under the base 1401 is in electrical contact with the pole piece 1410. Similar to the pickup 100, the pole piece 1410 carries the reference potential to a conductive coating located on the upper surface of the bobbin top 1505, which carries the reference potential to a conductive coating on the inside of the pickup cover 1402. The coatings and reference potential encase the pickup 1400 to shield it from ESI noise.

FIG. 16 is a schematic diagram showing the pickup 1400 in operation with electrical connections between it and an audio amplifier 1608 located at the right side of FIG. 16. The amplifier 1608 has an input phone jack 1621 with a tip contact 1604 and a sleeve contact 1605. The tip contact 1604 is electrically connected to an amplifier input terminal 1610, and the sleeve contact 1605 is electrically connected to an amplifier ground terminal 1611 which has a reference potential 1614. The amplifier 1608 also has two amplifier output terminals 1612, 1613 that can be connected to a speaker or other audio devices.

The left side of FIG. 16 shows the music instrument body 1504, the pickup 1400, a potentiometer volume control 1622, and an instrument output phone jack 1601 which has a tip contact 1602 and a sleeve contact 1603. The tip contact 1602 is electrically connected to the volume control 1622, and the sleeve contact 1603 is electrically connected to an instrument ground 1623, which includes the carbon coating on the body 1504.

In the conventional manner, electrical connections are made between the instrument and the amplifier 1608 by a shielded cable 1625 which has a left phone plug 1606 and a right phone plug 1607. The left phone plug 1606 includes a phone plug tip 1615 and a phone plug sleeve 1616. The right phone plug 1607 includes a phone plug tip 1617 and a phone plug sleeve 1618. The phone plug tips 1615, 1617 are connected by an inner wire 1620 of the shielded cable 1625, and the phone plug sleeves 1616, 1618 are connected by a shield 1619 of the shielded cable 1625. When the left phone plug 1606 is plugged into the output phone jack 1601 and the right phone plug 1607 is plugged into the input phone jack 1621, electrical connections 1624 are made to carry the reference potential from the ground terminal 1611 of the amplifier 1608 to the instrument ground 1623, and to carry the pickup output signal at the tip contact 1602 to the amplifier input terminal 1610.

As shown, the spring 1503 can support the weight of the pickup 1400, and can be a ground conductor for the pickup 1400 because it carries the amplifier reference potential 1614 for the pickup's ESI shield. The signal wires 1405, 1406 are connected to the volume control 1622 and the instrument ground 1623 respectively to apply the pickup output signal to the volume control 1622, which adjusts the signal volume and carries the signal to the tip contact 1602. One skilled in the art will notice that this schematic can be adapted to connect any of the pickups to the audio amplifier 1608. It can also be adapted to add other components such as tone control or preamplifier.

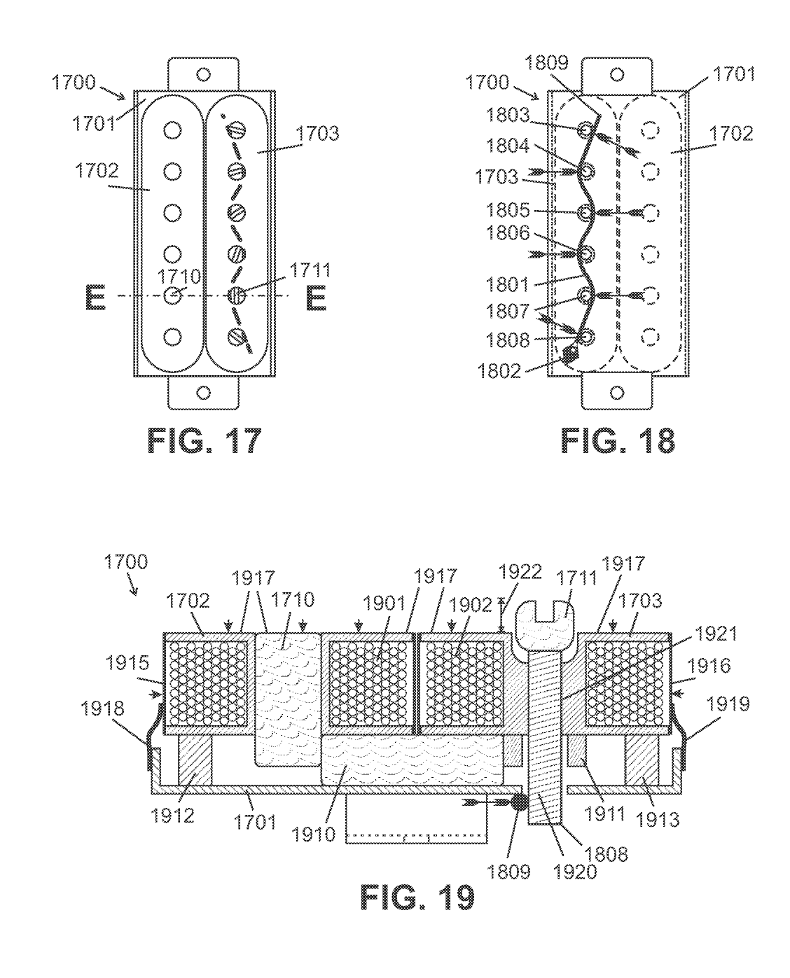

FIG. 17 is a top view of another exemplary embodiment of a double-coil (hum-bucking) pickup 1700 with ESI shielding. The pickup 1700 has a base 1701, a left wire bobbin 1702, a right wire bobbin 1703, and two pole pieces 1710, 1711. The pickup 1700 also has a ground wire (not shown) which is electrically connected to the base 1701 preferably by solder, and one or more signal wires (not shown) connected to coils in the bobbins 1702, 1703. The bobbins 1702, 1703 are electrical insulators. The base 1701 and the pole pieces 1710, 1711 are electrically conductive and preferably made of metal. The pole pieces 1710, 1711 are preferably made of a magnetic material such as steel or ferrous metal.

FIG. 18 is a bottom view of the pickup 1700 which shows a spring 1801 weaved between the bottoms of pole pieces 1803-1808. The spring 1801 can be a straight segment of wire 1809 made of stainless steel or music wire. The wire 1809 has “memory” because it springs back to a more or less straight condition when it is bent and released. Weaving the wire 1809 in between the pole piece bottoms 1803-1808 bends the wire 1809 into the wavy shape of the spring 1801 as shown. The wire's memory creates contact forces that are applied by the wire 1809 to the pole piece bottoms 1803-1808 as shown by large arrows. The large arrows indicate the approximate directions of the contact forces. The contact forces keep the spring 1801 in physical contact with the pole piece bottoms 1803-1808 to insure good electrical connections between the wire 1809 and the pole piece bottoms 1803-1808.

There is also an optional conductive coating area 1802 applied over the end of wire 1809 to insure a reliable electrical contact so that the spring 1801 receives the amplifier reference potential from the base 1701. The coating area 1802 is optional because there are six pole pieces in bobbin 1703 protruding through six holes in the base 1701. At least one of the pole pieces probably makes contact with the base 1701. Any pole piece that makes contact with the base 1701 will carry the reference potential to the other pole pieces via the spring 1801. But the conductive coating area 1802 is included to insure a reliable connection to carry the amplifier reference potential to the spring 1801. The wire 1809 does not have to have a round cross section or be straight. Any configuration that applies suitable contact forces to make electrical connections to the pole pieces can be utilized.

FIG. 19 shows a cross-section view E-E of the pickup 1700. It shows a coil of wire 1901, a coil of wire 1902, the pole pieces 1710, 1711, a permanent magnet 1910, a magnet bar 1911, two spacers 1912, 1913, and perimeter insulators 1915, 1916 which can be made of adhesive tape. The magnet 1910 and the perimeter insulators 1915, 1916 are electrical insulators. The magnet bar 1911 is preferably made of steel. Several short arrows indicate the many pickup surfaces that have conductive coatings. An external top surface 1917 of the bobbins 1702, 1703 and the pole piece 1710 has a conductive coating.

The pole piece 1711 has screw threads 1920 that engage matching hole threads 1921 in the bobbin 1703. The height 1922 of the pole piece 1711 above the bobbin 1703 can be adjusted by rotating the pole piece 1711. The force of the spring 1801 presses the wire 1809 against the bottom of the pole piece 1808 so that even after being rotated, the pole piece 1711 is in electrical contact with the wire 1809.

In this embodiment there are no conductive coatings under the bobbins 1702, 1703 to carry the reference potential to the pole pieces 1710, 1711, to the perimeter insulators 1915, 1916, or to the top surface 1917. Instead, there are two ground conductors 1918, 1919 that carry the reference potential from the base 1701 up to the perimeter tape 1915, 1916 and to the top surface 1917.

### Other Embodiments

Other kinds of musical instrument pickups can be treated similarly with conductive coatings and ground conductors to likewise provide better ESI shielding. For example, the body of a contact microphone can be conductive coated and grounded. And its output connector plug can be coated like the miniature phone plug 1307 as shown in FIG. 13. A carbon coating and a ground conductor can be applied to the exterior surface of any electrically insulated pickup wires that carry the pickup output signal, such as the signal wires 105, 106, to change the wires into carbon-coated shielded cable.

Various commercially available carbon coating products can be used. A product known as Conductive Shielding Paint is sold by Stewart-MacDonald Company. A half pint of the liquid is available as part number 0029. It is a water soluble paint that includes graphite and carbon black. It can be applied with a brush or a sprayer. When dried, the electrical resistance of the coating is typically less than 1000 ohms.

Another suitable product is carbon coating part number 838-340G manufactured by MG Chemicals Company. It is an aerosol can of spray paint which the manufacturer claims has better adhesion to plastics than water-base conductive paints. This manufacturer also makes an acrylic paint carbon coating with graphite. The part number is 839-1G for a one gallon can of liquid. MG Chemicals Company and another company, Henkel Corporation, make a variety of conductive inks, epoxies, glues, adhesives, films, pastes, grease, and lubricants which can be utilized for creating ground conductors. For example, MG Chemicals makes a metal coating with nickel. The part number is 841-340G for an aerosol can, part number 841-1G for a one gallon can. MG Chemicals also makes a metal coating with silver coated copper. The part number is 843-340G for an aerosol can, part number 843-1G for a one gallon can. This manufacturer also makes metal coatings with silver. The part number is 842-1G for a one gallon can. These materials can be applied like paint with a brush. They can be utilized to “paint” ground conductors that apply the reference potential to the carbon coating.

The solvents in carbon coatings may dissolve the enamel insulator overcoat on a pickup coil's magnet wire. When applied directly to a pickup coil, the carbon coating in its liquid state is likely to penetrate the enamel and make an electrical connection to the wire. This might be acceptable when the outer winding of the coil is to be grounded anyway. Otherwise, a solvent guard can be used to keep the carbon coating off of the coil and the other electrically conductive elements of the pickup, such as the solder eyelets 108,109. Some solvent guard examples are given above; for example, the bobbin top 201 and the air gap 220 of FIG. 2; the bobbins 715,716 and the adhesive tape 703 of FIG. 7; the glue plugs 1303, 1304 of FIG. 13; and the masked area 302 of FIG. 3. Some other suitable solvent guards may be hot glue, contact cement, or other materials or assembly methods that separate coils, eyelets, or wires from the carbon coating while it is in its liquid state.

Carbon coatings can be electrically connected to ground by various ground conductors. Some ground conductor examples are given above; for example, the pole piece 110 and conductive coating 210 of FIG. 2; the foil 301 of FIG. 3; the connecting wire 613 of FIG. 6; and the wire spirals 1308, 1309 of FIG. 13. Some other suitable ground conductor materials may be aluminum foil, conductive glue, conductive paint, conductive lubricants, conductive plastics, chrome plating, a conductive trace of a printed circuit board, or other materials that can provide an electrical connection to the carbon coating to carry the reference potential to the conductive coating or other ESI shield components.

The conductive coating can be applied over the ground conductor to provide more reliable electrical connections. But the reverse installation is acceptable so long as a suitable connection can be made to decrease ESI noise.

The carbon coatings and the ground conductors do not require low resistance in order to provide ESI shielding. A resistance of 47K ohms or less can be effective. Even higher resistance may be permissible providing that a substantial reduction in ESI noise is achieved.

The conductive coatings and ground conductors can operate with other kinds of shields to partially or completely encase ESI sensitive portions of the pickup. Good results can be achieved when 85% or more of the pickup's ESI sensitive surface area is encased by a grounded carbon coating operating alone or in conjunction with other kinds of electrostatic shields.

While exemplary embodiments incorporating the principles of the present invention have been disclosed, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains.

I claim:

1. A musical instrument pickup with an electrostatic interference (ESI) shield to substantially reduce audible ESI noise in an audio output signal of the pickup to be sent to an audio amplifier, the musical instrument pickup comprising:
a electrostatically sensitive surface;
a carbon coating shielding the electrostatically sensitive surface; and
a ground conductor electrically connected to the carbon coating to carry a reference potential of the audio amplifier to the carbon coating.

2. The musical instrument pickup of claim 1, wherein the carbon coating includes at least one of the following materials; carbon, carbon black, graphite, and an allotrope of carbon.

3. The musical instrument pickup of claim 2, wherein the carbon coating includes an electrically conductive component that includes metal.

4. The musical instrument pickup of claim 1, wherein the carbon coating includes a solvent for chemically etching the electrostatically sensitive surface to help adhere the carbon coating to the electrostatically sensitive surface.

5. The musical instrument pickup of claim 1, wherein the surface with the carbon coating is a member of at least one of the following; a pickup cover, a pickup base, a bobbin top, a split bobbin, a wire bobbin, a plastic tube, and a tube casing.

6. The musical instrument pickup of claim 1, wherein the surface with the carbon coating shields at least one bobbin with a coil of wire.

7. The musical instrument pickup of claim 1, wherein the surface with the carbon coating is an inner wire of a shielded cable.

8. The musical instrument pickup of claim 1, wherein the surface with the carbon coating is an exterior surface of the musical instrument pickup, and the carbon coating is black in color.

9. The musical instrument pickup of claim 1, wherein the ground conductor includes at least one of the following; a copper foil, a bare wire, a spring, a pole piece, a conductive coating, and a second carbon coating.

10. The musical instrument pickup of claim 1, further comprising a solvent guard for keeping the carbon coating off of an electrically conductive element of the musical instrument pickup.

11. The musical instrument pickup of claim 1, wherein the audio amplifier includes an input terminal and a ground terminal having the reference potential, the musical instrument pickup further comprising:
a first electrical connection for carrying the audio output signal of the musical instrument pickup to the input terminal of the audio amplifier, and
a second electrical connection for carrying the reference potential from the ground terminal of the audio amplifier to the ground conductor of the ESI shield of the musical instrument pickup.

12. The musical instrument pickup of claim 1, further comprising a piezoelectric member for providing the audio output signal of the pickup.

13. A musical instrument pickup comprising:
a coil of wire for producing an audio output signal,
a pole piece inside the coil of wire,
a conductive coating in electrical contact with the pole piece, and
a ground conductor electrically connected to the conductive coating for carrying a reference potential to the pole piece to shield the inside of the coil of wire from electrostatic interference (ESI) noise.

14. The musical instrument pickup of claim 13 further comprising a bobbin for the coil of wire and the conductive coating, wherein the coil of wire is wound on the bobbin and the conductive coating is applied to an inner surface of the bobbin.

15. The musical instrument pickup of claim 13 wherein the ground conductor includes at least one of the following: a copper foil, a bare wire, a spring, a pole piece, a second conductive coating, and a carbon coating.

16. The musical instrument pickup of claim 13 wherein the conductive coating comprises at least one of the following: an electrically conductive component of the conductive coating not made of carbon, and an electrically conductive component of the conductive coating made of carbon.

17. The musical instrument pickup of claim 13 further comprising a second coil of wire.

18. A pickup for a musical instrument comprising:
a coil of wire for providing an audio output signal,
an external top surface of the pickup;
a conductive coating applied to the external top surface of the pickup;
a ground conductor electrically connected to the conductive coating for carrying a reference potential of an audio amplifier to the conductive coating to shield the pickup from electrostatic interference (ESI) noise.

19. The pickup of claim 18 wherein the conductive coating is black in color.

20. The pickup of claim 18 wherein the conductive coating has at least one of the following materials: carbon, carbon black, graphite, an allotrope of carbon, silver, and copper.

21. The pickup of claim 18 further comprising a colorant in the conductive coating.

22. The pickup of claim 18 further comprising an overcoating over the conductive coating.

23. The pickup of claim 18 further comprising a second coil of wire.

24. A pickup for a musical instrument comprising:
a coil of wire for providing an audio output signal;
a plurality of pole pieces located in the coil of wire; and
a spring for carrying a reference potential of an audio amplifier for the pole pieces.

25. The pickup of claim 24 further comprising:
a base of the pickup;
a conductive coating applied over the base, the spring being electrically connected to the base.

26. The pickup of claim 25 further comprising a ground wire electrically connected to the base to apply the reference potential to the base, the conductive coating, the spring, and the pole pieces.

27. The pickup of claim 24 further comprising a bobbin for the coil of wire and a conductive coating applied over the top surface of the bobbin.

28. The pickup of claim 24 further comprising a base with a hole, each of the pole pieces extending through the base.

29. The pickup of claim 24 wherein the spring includes a wire weaved between the pole pieces to provide contact forces to the pole pieces to provide electrical connections between the spring and the pole pieces.
